(19) United States
(12) Patent Application Publication
(10) Pub. No.: US 2016/0019649 A1
(43) Pub. Date: Jan. 21, 2016

(54) SYSTEM AND METHOD FOR PROVIDING AN ANALYSIS OF THE RELATIVE VOLATILITY OF ASSET CLASSES

(71) Applicant: John Hancock Life Insurance Company (U.S.A.), Boston, MA (US)

(72) Inventors: Eric Lachance, Boston, MA (US); Kevin McMahon, Boston, MA (US); Daniel Rollins, Boston, MA (US); Brigham Prescott, Boston, MA (US)

(21) Appl. No.: 14/866,462

(22) Filed: Sep. 25, 2015

Related U.S. Application Data
(63) Continuation of application No. 14/137,370, filed on Dec. 20, 2013, now abandoned.
(60) Provisional application No. 61/914,595, filed on Dec. 11, 2013.

(51) Int. Cl. G06Q 40/06

(52) U.S. Cl. CPC G06Q 40/06

(57) ABSTRACT

The disclosed technology relates generally to a method and system for evaluating asset classes and investment categories. Financial advisors, for example, may use the disclosed technology to talk to investors about diversification. The disclosed technology allows users to explore and visualize the concept of diversification. The disclosed technology may also be used to help explain and reinforce the importance of diversification by highlighting the relative volatility of the asset classes. The disclosed technology, in certain embodiments, lets users explore performance of asset classes in several investment categories (e.g., equity, fixed-income, and alternatives) and shows how a diversified portfolio would have performed over the same time period.

### PRIORITY APPLICATIONS

The present application is a Continuation of U.S. patent application Ser. No. 14/137,370, entitled “System and Method for Providing an Analysis of the Relative Volatility of Asset Classes” and filed Dec. 20, 2013, and claims priority to U.S. Provisional Application No. 61/914,595 entitled “System and Method for Providing an Analysis of the Relative Volatility of Asset Classes” and filed Dec. 11, 2012, the contents of both of which are hereby incorporated by reference in their entirety.

### BACKGROUND OF THE INVENTION

Financial advisors typically work with clients to help them with budget plans, investment decisions, home purchases, estate planning, income tax preparation, and often help clients manage their money. Financial advisors typically help clients manager their money to build a financial portfolio that will accumulate a sufficient amount of funds at retirement and beyond. While advising clients, financial advisors often explain investment strategies and the importance of diversification. Moreover, financial planners are typically tasked with providing clients with an understanding of certain investing principles including the value of diversification. Clients benefit from understanding both the historical performance of asset classes in several investment categories (e.g., equity, fixed-income, and alternatives) and how a diversified portfolio would have performed over the same time period when working with a financial advisor to develop a financial plan.

Investment planning tools often lack the ability to present investment options in a way that is both user-friendly and that conveys important information about both the volatility involved with a given investment strategy and the importance of diversification. Clients often cannot easily visualize the concept of diversification and the volatility of certain asset classes.

Thus, there is a need for a user-friendly retirement investment planning tool that adequately conveys at a glance how different asset classes have performed over time. Additionally, there is a need for a tool that allows users to explore and visualize the concept of diversification. Moreover, there is a need for a user-friendly interactive tool that allows users to graphically highlight and compare the relative volatility of the asset classes presented.

### SUMMARY OF THE INVENTION

The disclosed technology relates generally to a method and system for evaluating asset classes and investment categories. Financial advisors, for example, may use the disclosed technology to talk to investors about diversification. The disclosed technology allows users to explore and visualize the concept of diversification. The interactive tool may also be used to help explain and reinforce the importance of diversification by highlighting the relative volatility of the asset classes. The disclosed technology, in certain embodiments, lets users explore performance of asset classes in several investment categories (e.g., equity, fixed-income, and alternatives) and shows how a diversified portfolio would have performed over the same time period.

The disclosed technology, in certain embodiments, shows at a glance how different asset classes have performed in different market environments, including the benefits of incorporating alternatives into an investment portfolio. Moreover, the interactive tool may be used to analyze the performance of various asset classes in a specific investment category over time. Functionality built into the interactive tool allows users to graphically highlight and compare the relative volatility of the asset classes presented. The disclose technology, in some implementations, includes a computer-implemented method for displaying financial asset performance information. The method may include the step of receiving, by a processor of a computing device, financial performance information for a set of asset classes in one or more investment categories, wherein: (i) the financial performance information includes, for each asset class, a return for each time period of a set of time periods, and (ii) each asset class is associated with one of the one or more investment categories, and the one or more investment categories are selected from the group consisting of equities, fixed income, alternatives, and mixed. In certain embodiments, the set of time periods is a set of years and the return is an annual return. In certain embodiments, the one or more investment categories include an equities, fixed income, alternatives, and a mixed investment category.

The method may include providing, by the processor, a graphical user interface configured to accept user input and receiving, by the processor, a selection of an investment category, wherein: (i) the graphical user interface displays a matrix of financial performance information arranged on a first axis by the set of time periods and on a second axis by financial performance, (ii) for each time period of the set of time periods, the matrix includes an entry corresponding to each asset class of the set of asset classes associated with the selected investment category, and (iii) the entries in the matrix for each time period of the set of time periods are organized based on the financial performance information in the corresponding time period. The selection of the investment category may be received from a computing device associated with a user.

The method may further include receiving, by the processor, a selection by a user of an entry in the matrix, wherein the selected entry corresponds to a selection of an asset class associated with the selected investment category and graphically highlighting, on the graphical user interface, by the processor, all entries in the matrix over the set of time periods corresponding to the selected asset class. Graphically highlighting all entries in the matrix corresponding to the selected asset class may include a line connecting each of the entries in the matrix in the selected asset class and/or a first background color for each of the entries in the matrix in the selected asset class and a second background color for all entries in the matrix that are not in the selected asset class. The graphical user interfaces may display the growth of an investment amount (e.g., $10,000) over a time period (e.g., a year).

The set of asset classes associated with the selected investment category may include a diversified asset class, and for each time period of the set of time periods, the matrix includes an entry corresponding to the diversified asset class that represents an average annual return for each given time period of the other members of the set of asset classes associated with the selected investment category.

The method may further include receiving, by the processor, a selection by the user of a second investment category; and updating, by the processor, the graphical user interface display a matrix with an entry corresponding to each asset class of the set of asset classes associated with the second investment category.

In certain embodiments, the selected investment category is a mixed investment category, and the mixed investment category includes asset classes associated with the equities, fixed income, and alternatives investment category. In certain embodiments, the selected investment category is the fixed income investment category, and the method further includes receiving, by the processor, federal interest rate information for each time period of the set of time period; and providing, by the processor, for display on the graphical user interface, the federal interest rate information. The federal interest rate information may be provided, for display on the graphical user interface, as a line graph of fed interest rate information as a function of time.

In certain embodiments, the method includes providing, by the processor, one or more graphical user interface widgets that allow adjustment of the percentage of the mixed investment category that comprises asset classes associated with each of the equities, fixed income, and alternatives investment category. The method may further include providing, for display on the graphical user interface, an average annual return over a period of time for each asset class in the selected investment category.

In certain embodiments, the asset classes associated with the equities investment category include small-cap growth, small-cap value, mid-cap growth, foreign equities, mid-cap value, large-cap value, large blend, and large-cap growth.

In certain embodiments, the asset classes associated with the fixed income investment category include high yield, foreign bonds, bank loans, corporate bonds, municipal bonds, government bonds, 10-year U.S. treasury, and cash.

In certain embodiments, the asset classes associated with the alternatives investment category include precious metals, global real estate, emerging markets debt, commodities, buy/write, long/short equity, and market neutral.

In certain embodiments, the asset classes associated with the mixed investment category include one or more asset classes selected from the asset classes associated with the equities, the fixed income, and/or the alternatives investment category.

The disclosed technology, in certain embodiments, includes a system for displaying financial asset performance information. The system may include a processor configured to process data to display financial asset performance information, wherein the processor is configured to execute instructions to: (i) receive financial performance information for a set of asset classes in one or more investment categories, wherein: the financial performance information includes, for each asset class, a return for each time period of a set of time periods, each asset class is associated with one of the one or more investment categories, and the one or more investment categories are selected from the group consisting of equities, fixed income, alternatives, and mixed, (ii) provide a graphical user interface configured to accept user input, (iii) receive a selection of an investment category, wherein: the graphical user interface displays a matrix of financial performance information arranged on a first axis by the set of time periods and on a second axis by financial performance, for each time period of the set of time periods, the matrix includes an entry corresponding to each asset class of the set of asset classes associated with the selected investment category, and the entries in the matrix for each time period of the set of time periods are organized based on the financial performance information in the corresponding time period; (iv) receive a selection by a user of an entry in the matrix, wherein the selected entry corresponds to a selection of an asset class associated with the selected investment category; and (v) graphically highlight, on the graphical user interface, all entries in the matrix over the set of time periods corresponding to the selected asset class.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 illustrates an example graphical user interface for evaluating the performance of asset classes in an investment category;

FIG. 2 illustrates an example graphical user interface for graphically highlighting entries in a matrix associated with an asset class;

FIG. 3 illustrates an example graphical user interface for graphically highlighting entries in a matrix associated with an asset class;

FIG. 4 illustrates an example graphical user interface for graphically comparing performance of an asset class and a diversified portfolio;

FIG. 5 illustrates an example graphical user interface for exploring investment options in a specific investment category;

FIG. 6 illustrates an example graphical user interface for viewing a profile of an investment fund;

FIG. 7 illustrates an example graphical user interface for evaluating the performance of asset classes in a fixed-income investment category;

FIG. 8 illustrates an example graphical user interface for evaluating the performance of asset classes in an alternatives investment category;

FIG. 9 illustrates an example graphical user interface for evaluating the performance of asset classes in an equities investment category;

FIG. 10 illustrates an example graphical user interface for evaluating the performance of asset classes in a mixed investment category;

FIG. 11 illustrates an example graphical user interface for adjusting the mixture of investments in diversified portfolio;

FIG. 12 is a flowchart of a method for graphically highlighting the relative volatility of asset classes;

FIG. 13 illustrates an example graphical user interface for evaluating the performance of an asset class relative to federal interest rate information;

FIG. 14 shows a block diagram of an exemplary cloud computing environment; and

FIG. 15 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION OF THE INVENTION

In some implementations, the disclosed technology includes an interactive tool for evaluating the performance of asset classes and investment categories. The interactive tool may be used to analyze the performance of various asset classes in a specific investment category over time. In some implementations, functionality built into the interactive tool allows users to graphically highlight and compare the relative volatility of the asset classes presented. The interactive tool may also be used to help explain and reinforce the importance of diversification by highlighting the relative volatility of the asset classes.

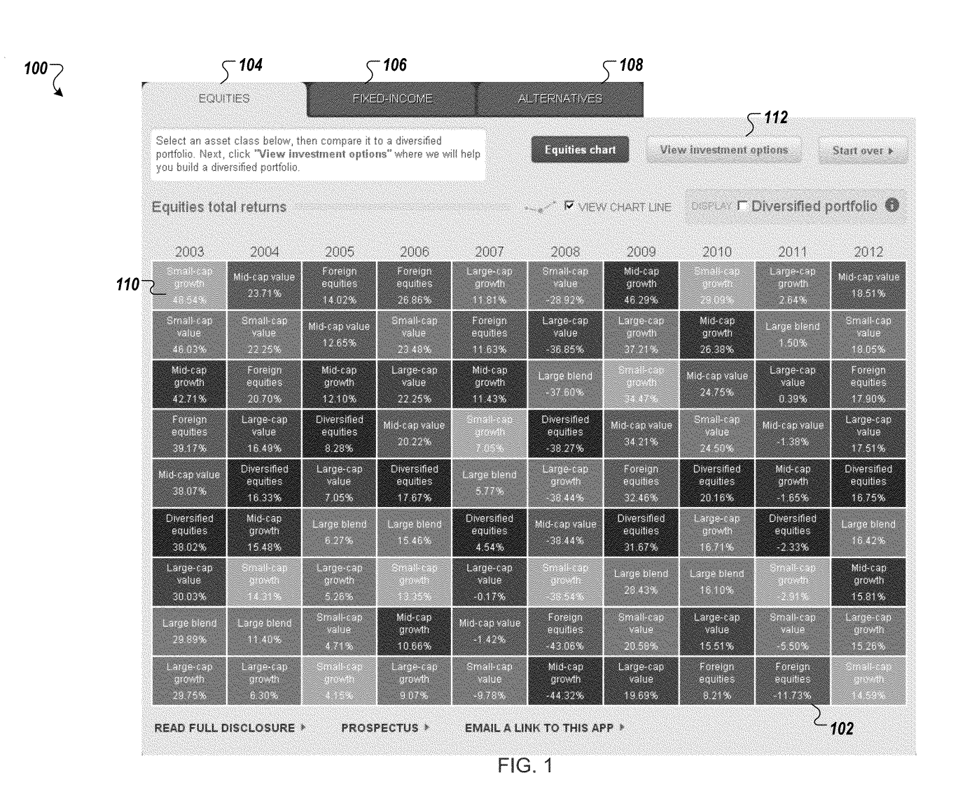

FIG. 1 illustrates example graphical user interface 100 for evaluating the performance of asset classes and investment categories. The graphical user interface 100 includes a matrix 102 of financial performance information is arranged on a first axis by time and on a second axis by financial performance. Matrix 102 illustrates the performance of eight asset classes and a diversified portfolio in the equities investment category. A user may select the investment category they want to view by selecting a widget, such as a tab. For example, a user may select the equities tab 104, fixed-income tab 106, or the alternatives tab 108 to view financial performance information for an equities, fixed-income, or alternatives investment category, respectively. Each investment category may include a unique set of asset classes. For example, FIG. 1 illustrates a graphical user interface 100 that provides financial performance information for an equities investment category. The asset classes associated with the equities investment category may include small-cap growth, small-cap value, mid-cap growth, foreign equities, mid-cap value, large-cap value, large blend, and/or large-cap growth asset classes. Matrix 102 provides information for each asset class in a specific investment category (e.g., the equities investment category) for a set of periods.

The matrix 102 includes, for example, a column for each year from 2003 to 2012. In some implementations, the time period is days, weeks, months, years, or decades. For each time period (e.g., year), the matrix includes an entry corresponding to each asset class of the set of asset classes associated with the selected investment category (e.g., the equities investment category). As shown in FIG. 1, each year from 2003 to 2012 includes an entry in matrix 102 for each of the small-cap growth, small-cap value, mid-cap growth, foreign equities, mid-cap value, large-cap value, large blend, and/or large-cap growth asset classes. A user can view matrix 102 to identify the volatility of each of the displayed asset classes. Each asset class shown in matrix 102 may be assigned a unique color. The color coding may allow users to more readily identify and compare the performance of each asset class shown in matrix 102.

Matrix 102 may include an asset class representing a diversified equities portfolio. The diversified equities portfolio may be representative of the average return of the other asset classes shown in matrix 102. For example, in the column corresponding to the year 2003, the asset class representing the diversified equities portfolio shown is the average return of the other asset classes in the column corresponding to the year 2003.

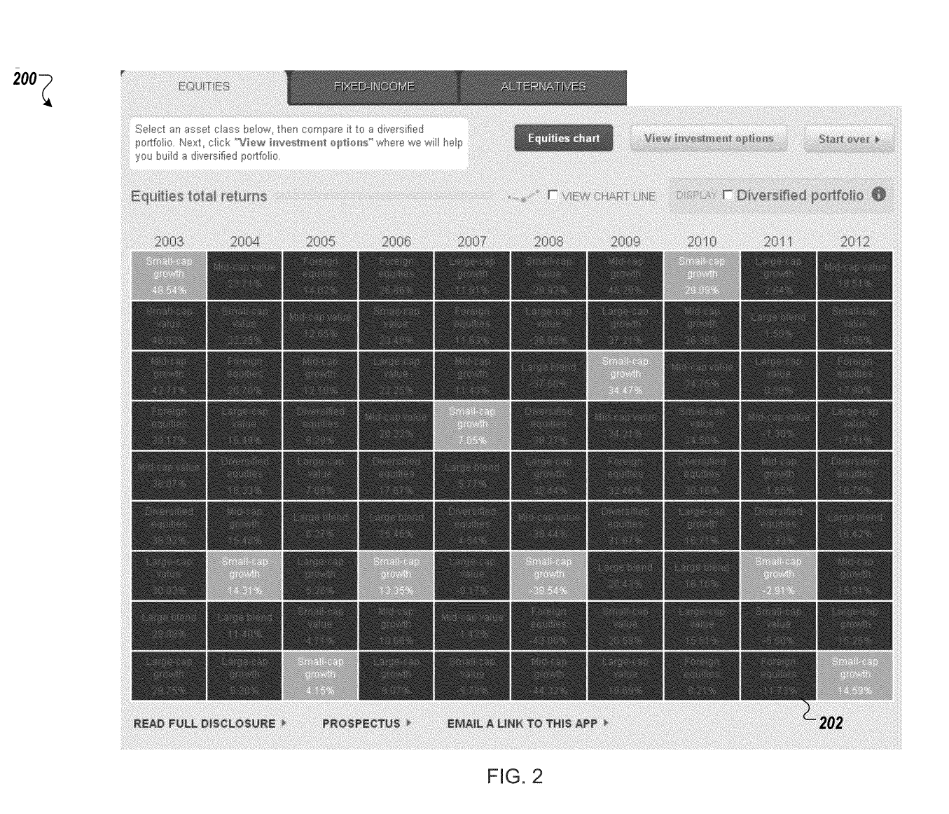

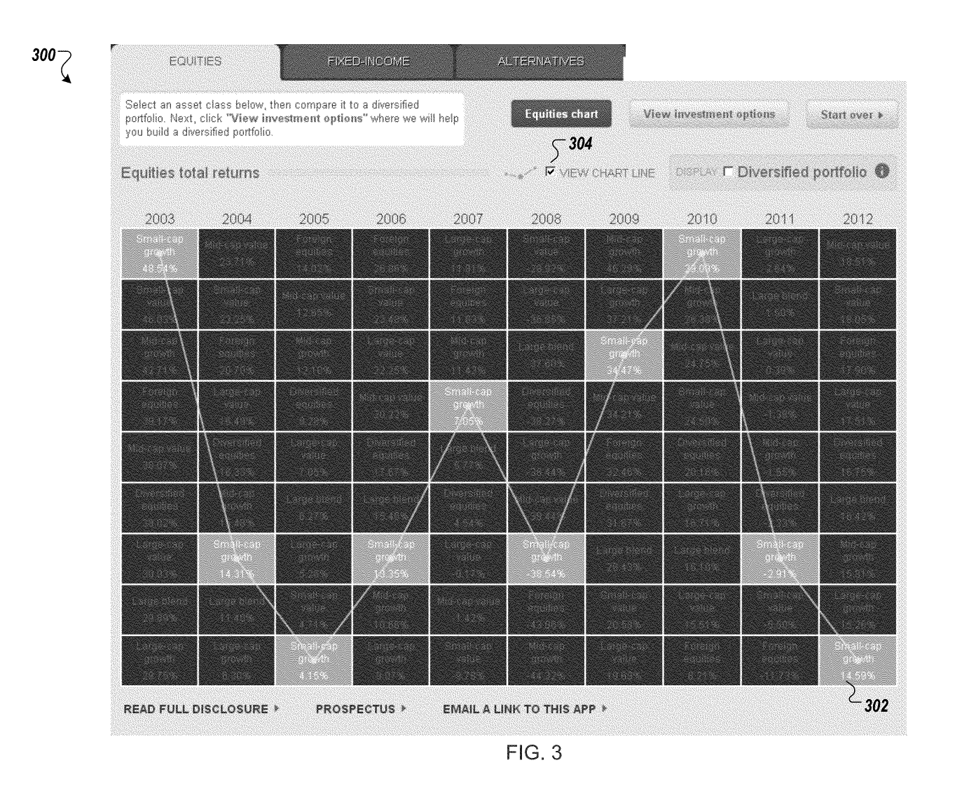

FIG. 2 illustrates example graphical user interface 102 for evaluating the performance of an asset class. Selection of a specific asset class in any given year, such as entry 110 in matrix 102 as shown in FIG. 1, highlights that asset class as shown in FIG. 2. The selected asset class may be graphically highlighted by shading all entries in the matrix that are not in the selected asset class. For example, as shown in FIG. 2, all entries in the matrix 202 are shaded gray except entries representing the small-cap growth asset class (the selected asset class). The selected asset class may be graphically highlighted by a line connecting each of the entries in the matrix in the selected asset class. In some implementations, selected asset class may be graphically highlighted (i) by shading all entries in the matrix that are not in the selected asset class and (ii) a line connecting each of the entries in the matrix 302 in the selected asset class, as shown in FIG. 3. In some implementations, a line connecting each of the entries in the matrix 302 in the selected asset class is shown when a user selects widget 304.

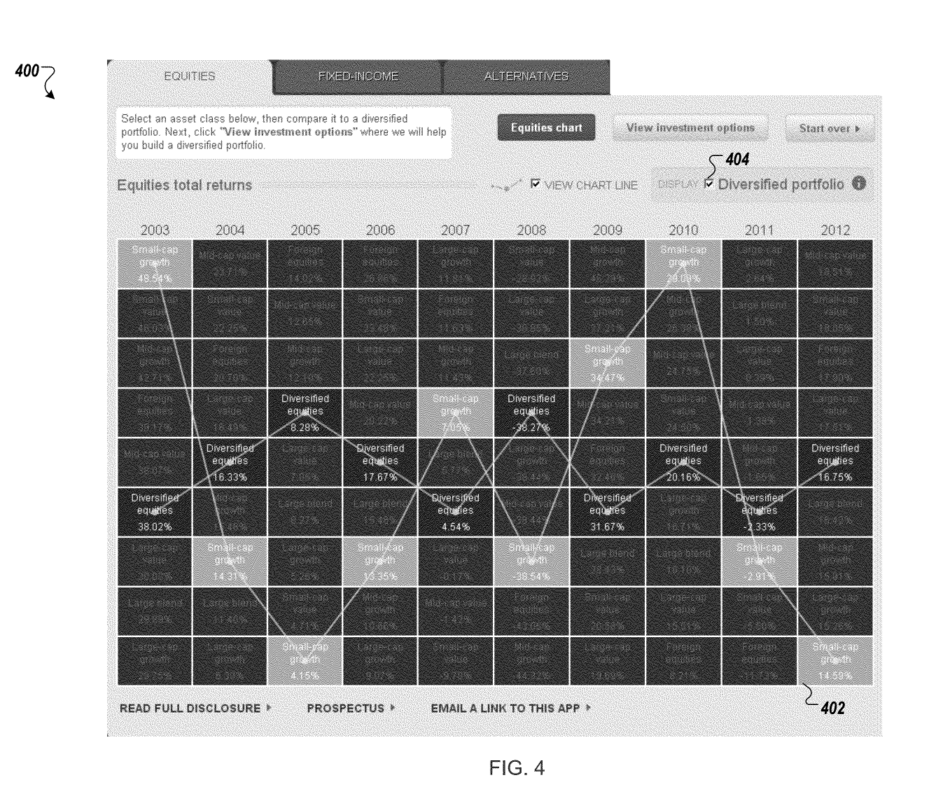

FIG. 4 is example graphical user interface 400 for comparing the financial performance of an asset class to a diversified portfolio. A matrix 402 illustrates the performance of eight asset classes and a diversified portfolio in the equities investment category. A user may select an asset class as described in relation to FIG. 3. A user may also select a widget 404 to graphically highlight the diversified portfolio asset class in the matrix 402. This functionality also allows users to highlight and compare the relative volatility of the asset classes presented. For example, the user may highlight and compare the selected asset class and the diversified portfolio asset class as shown in FIG. 4. The interactive tool may also be used to help explain and reinforce the importance of diversification by highlighting the relative volatility as shown in FIG. 4.

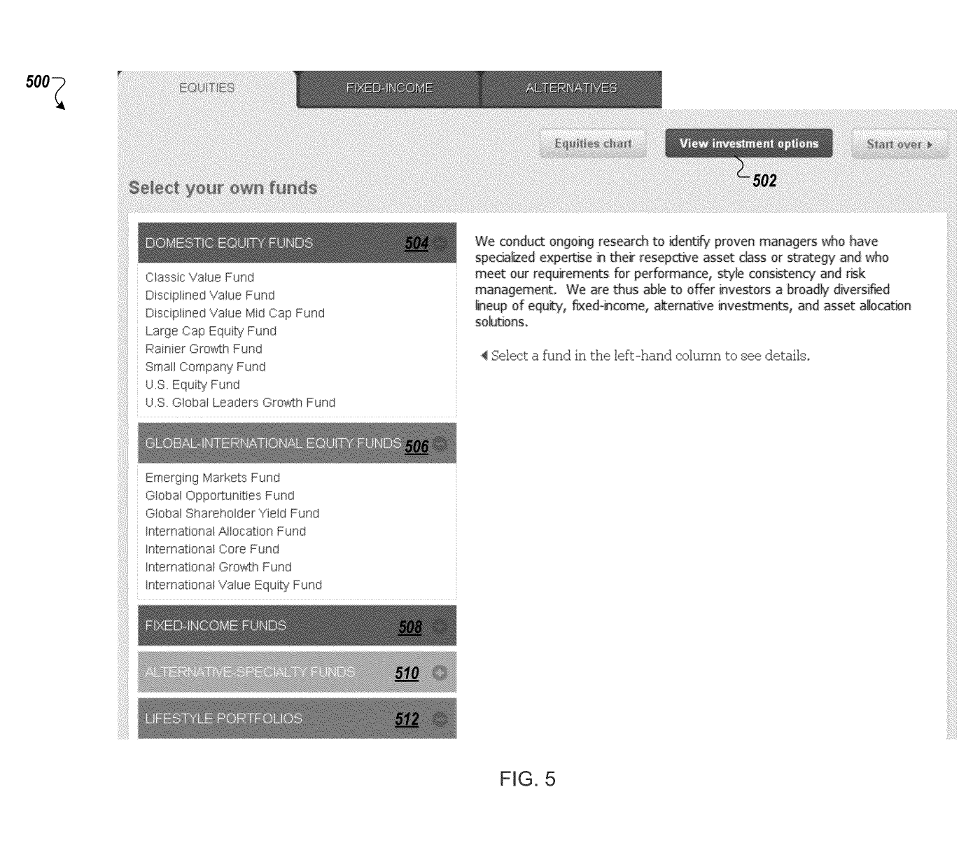

FIG. 5 illustrates example graphical user interface 500 for exploring investment options in a specific investment category. In some implementations, a user may wish to explore investment options in a specific investment category. Users may access graphical user interface 500 by selecting a “View Investment Options” widget 502. The investment options may be grouped based on the investment category. For example, graphical user interface 500 illustrates various investment options including domestic equity funds 504, global-international equity funds 506, fixed-income funds 508, alternative-specialty funds 510, and lifestyle portfolios 512. The investment categories may be expanded or collapsed to view or hide a list of investment options in each investment category.

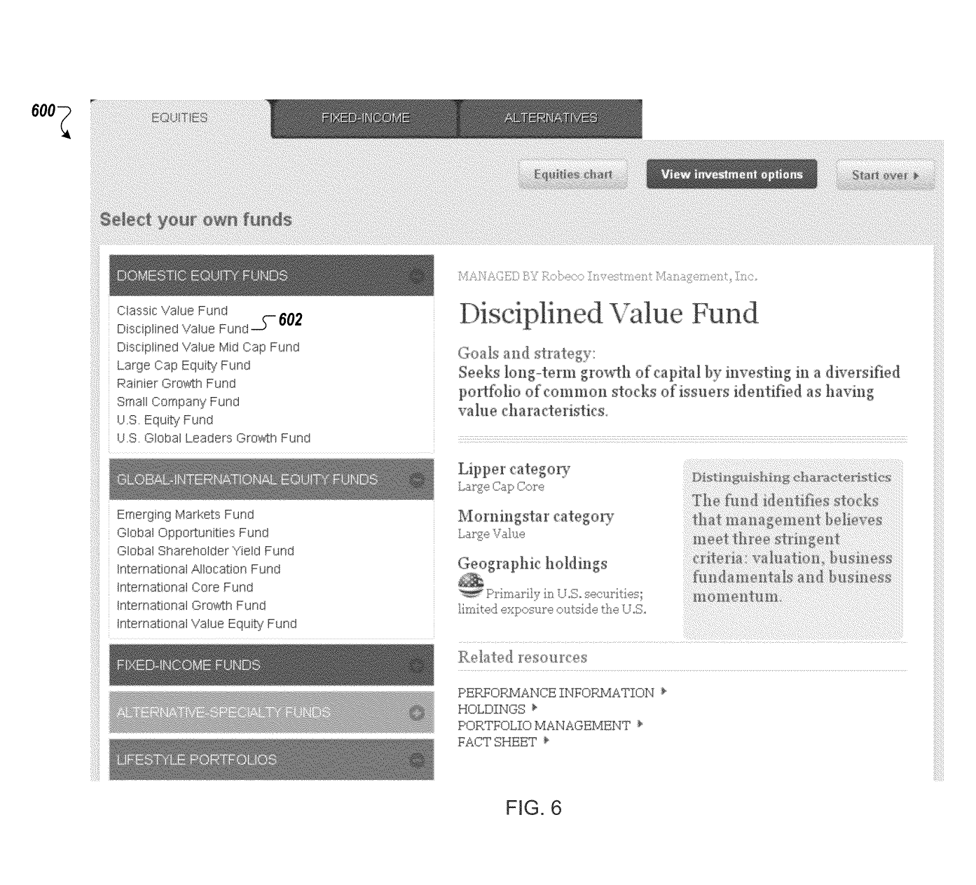

In some implementations, each list of investment options (e.g., each investment category) are expanded or collapsed automatically based on the path the user took to get to graphical user interface 500. For example, as shown in FIG. 5, the user either (i) selected a widget to view equity investment options from a landing page or (ii) was viewing an equities matrix (e.g., matrix 102 as shown in FIG. 1) and selected view investment options 502 (e.g., view investment options 112 as shown in FIG. 1). In some implementations, as illustrated by example graphical user interface 600 in FIG. 6, users may select a fund 602 (e.g., Disciplined Value Fund) from the list of investment options. Information about the fund 602 may be provided via graphical user interface 600. Graphical user interface 600 may provide users with the option of viewing performance information, holdings information, and/or a factsheet for the selected fund 602. Graphical user interface 600 may also provide users with the option of viewing the portfolio management team for the selected fund.

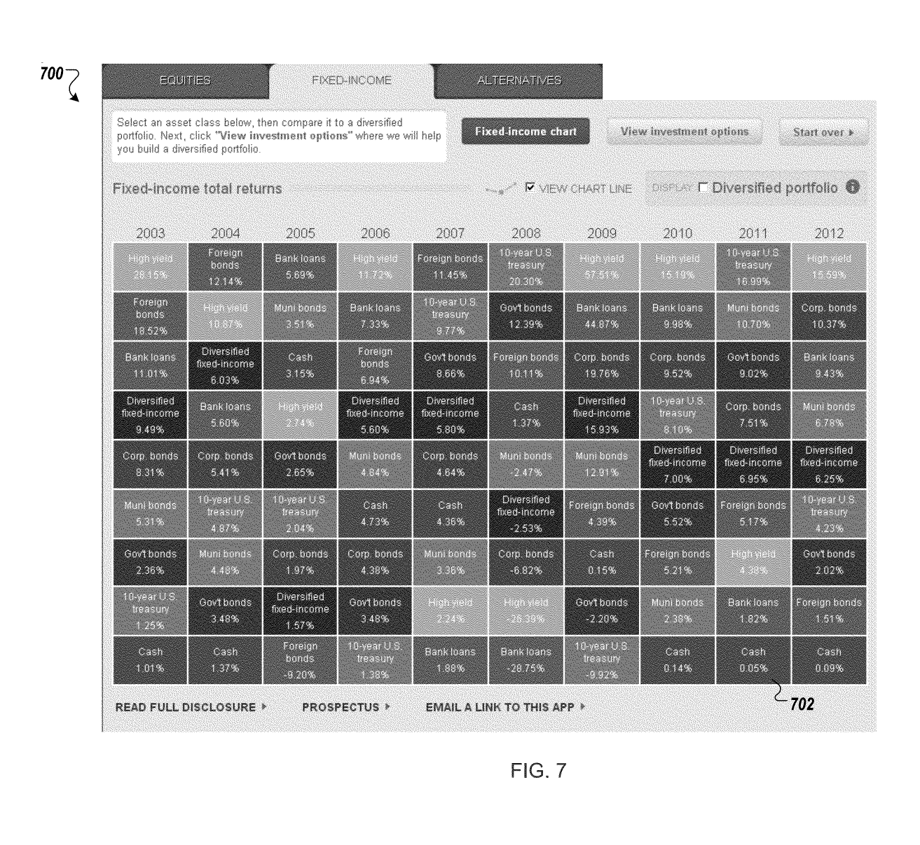

FIG. 7 illustrates example graphical user interface 700 that displays financial performance information for a fixed-income investment category. The matrix 702 includes asset classes associated with the fixed-income investment category. The asset classes associated with the fixed income investment category may include high yield, foreign bonds, bank loans, corporate bonds, municipal bonds, government bonds, 10-year U.S. treasury, and cash. User may use graphical user interface 700 in a similar manner to that described in relation to FIG. 1.

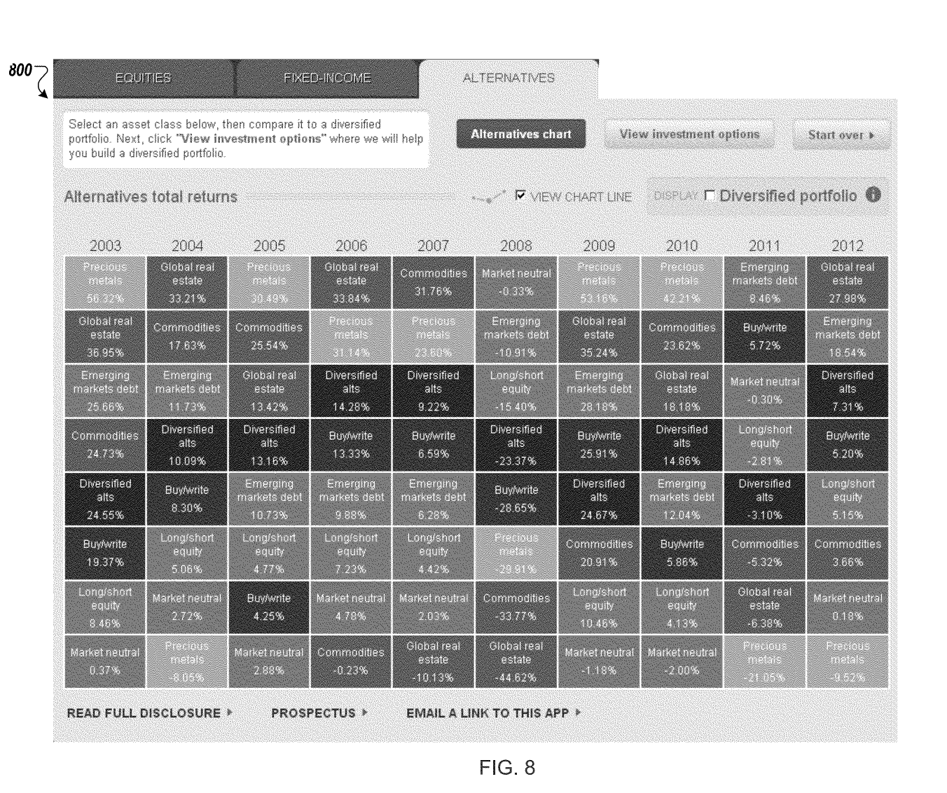

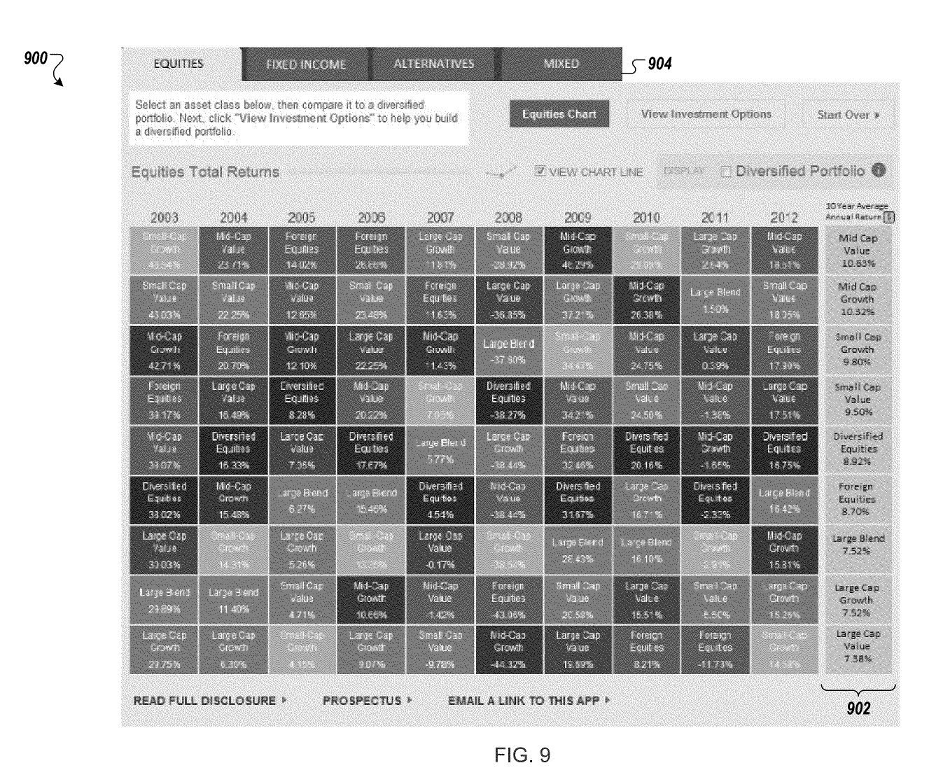

FIG. 8 illustrates example graphical user interface 800 that displays financial performance information for an alternatives investment category. The matrix 802 includes asset classes associated with the alternatives investment category. The asset classes associated with the alternatives investment category may include precious metals, global real estate, emerging markets debt, commodities, buy/write, long/short equity, and/or market neutral. User may use graphical user interface 800 in a similar manner to that described in relation to FIG. 1. FIG. 9 illustrates example graphical user interface 900 that displays financial performance information for an equities investment category. In some implementations, the graphical user interface 900 displays an average annual return 902 over a period of time for each asset class in the selected investment category as shown in FIG. 9. A graphical user interface, such as graphical user interface 900, may display the growth of an investment amount (e.g., $10,000) over a time period (e.g., 10 years). This feature may be incorporated into a graphical user interface that displays, for example, financial performance information for a fixed income, alternatives, mixed, or equities investment category. The growth of the investment amount over the time period may be displayed for each asset class in the selected investment category. In some implementations, a user may toggle between displaying the average return of asset classes (as shown in FIG. 9) and displaying the growth of an investment amount over a time period.

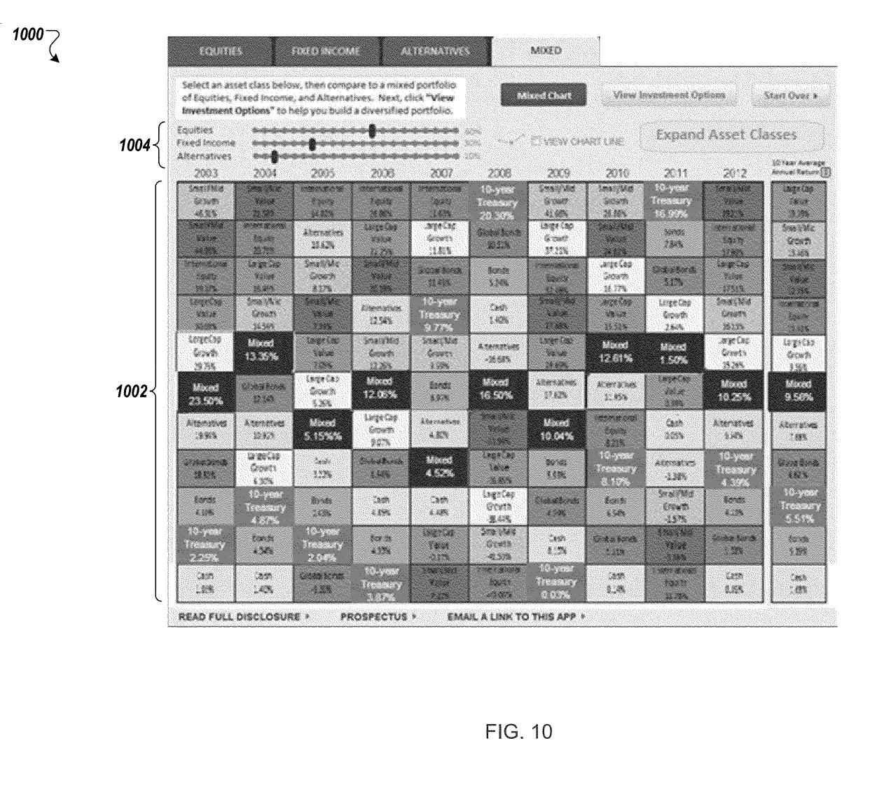

In some implementations, the graphical user interface 900 includes a widget 1204 that can be selected to display financial performance information for a mixed investment category as shown in FIG. 10. FIG. 10 illustrates example graphical user interface 1000 that displays financial performance information for a mixed investment category. The matrix 1002 includes asset classes associated with the mixed investment category. The asset classes associated with the mixed investment category may include one or more asset classes selected from the asset classes associated with the equities, the fixed income, and/or the alternatives investment category. A user may use graphical user interface 1000 in a similar manner to that described in relation to FIG. 1.

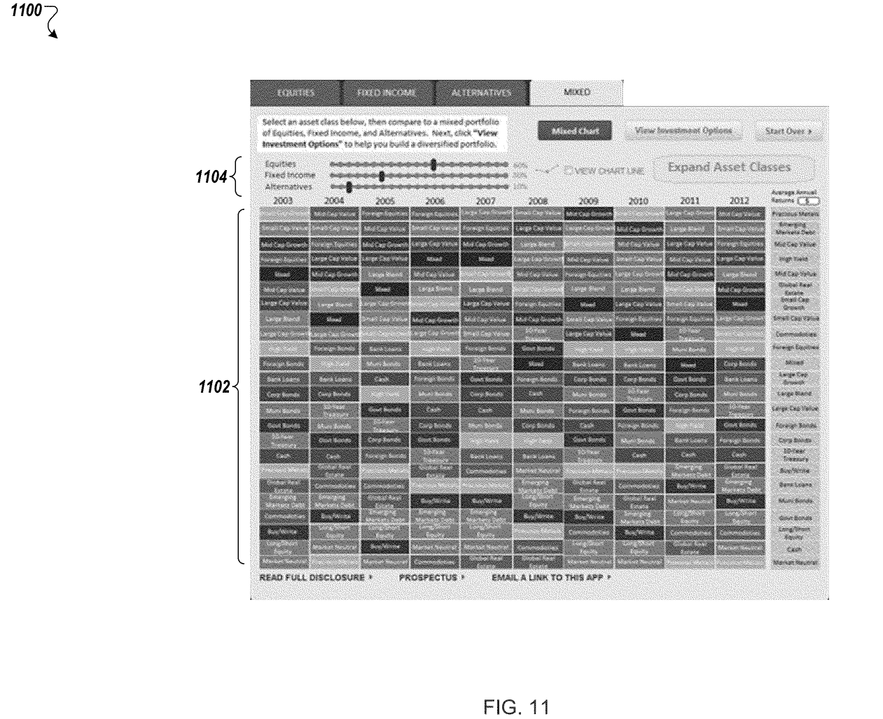

FIG. 11 is illustration of an example graphical user interface 1100 that displays asset classes for a plurality of investment categories. For example, graphical user interface 1100 illustrates all of asset classes for the equities, fixed income, and alternatives investment categories. The matrix 1102 may include a diversified portfolio that is made up of a mixture of equities, fixed income, and alternatives investments. Graphical user interface 1100 may include a widget 1104 that allows a user to adjust the mixture of equities, fixed-income, and alternative investments in the diversified portfolio in matrix 1102. The adjustment may be on a percentage basis.

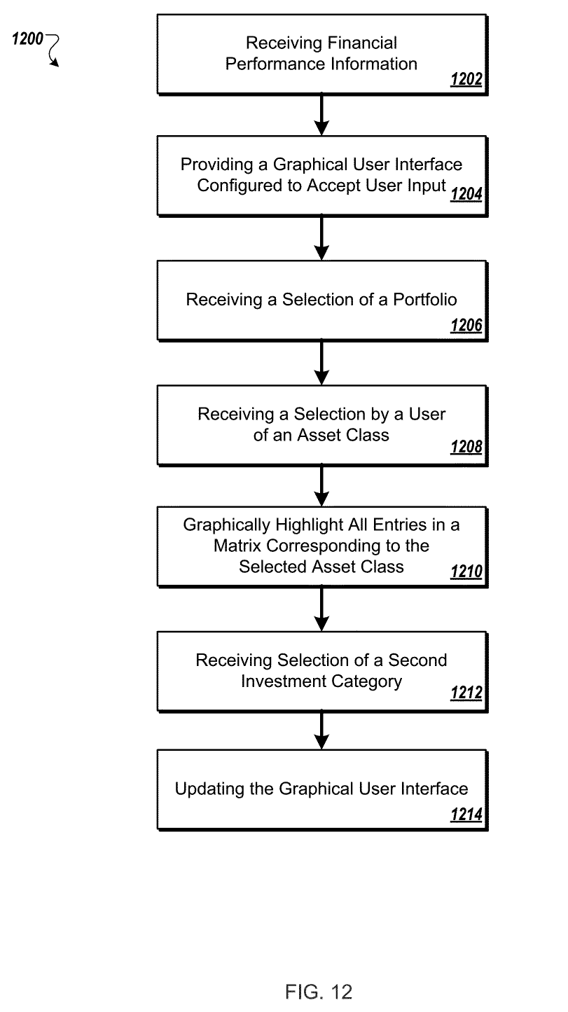

FIG. 12 illustrates a method 1200 providing an analysis of asset classes and investment categories. In some implementations, method 1200 includes receiving financial performance information for a set of asset classes in one or more investment categories (1202). The financial performance information may include a return, such as an annual return, each time period of a set of time periods. The set of time periods may be a set of years, weeks, days, months, decades, or other similar periods. The investment categories may be an equities, fixed income, alternatives, and/or mixed investment category. The asset classes in each investment category may be unique to the investment category. The entries in the matrix for each time period of the set of time periods may be organized based on the financial performance information in the corresponding time period.

In some implementations, the method 1200 includes providing a graphical user interface configured to accept user input (1204). The graphical user interface may be one or more of the graphical user interface(s) described in FIGS. 1-11. The user may provide input to the system via a touch screen, touch pad, keyboard, mouse, voice commands, gestures, or other similar devices/methods.

The method 1200 may include receiving a selection of an investment category (1204). The system may select an investment category by default or the system may receive a selection made by a user. In response to the selection, the graphical user interface may display a matrix of financial performance information arranged on a first axis by the set of time periods and on a second axis by financial performance as shown, for example, in FIG. 1. For each time period of the set of time periods, the matrix may include an entry corresponding to each asset class of the set of asset classes associated with the selected investment category. The entries in the matrix for each time period of the set of time periods may be organized based on the financial performance information in the corresponding time period.

The method 1200 may include receiving a selection by a user of an entry in the matrix (1208). The selected entry corresponds to a selection of an asset class associated with the selected investment category. In some implementations, after a user selects an entry in the matrix, the system graphically highlights, on the graphical user interface, by the processor, all entries in the matrix over the set of time periods corresponding to the selected asset class.

In some implementations, the set of asset classes associated with the selected investment category includes a diversified asset class. For each time period of the set of time periods, the matrix may include an entry corresponding to the diversified asset class that represents an average annual return for each given time period of the other members of the set of asset classes associated with the selected investment category.

In some implementations, the method 1200 includes receiving a selection by the user of a second investment category (1212). After receiving a selection of a second investment category, the system, in some implementations, updates the graphical user interface to display a matrix with an entry corresponding to each asset class of the set of asset classes associated with the second investment category. For example, a user may view a graphical user interface such as the graphical user interface 100 shown in FIG. 1. The user may select a either the fixed-income widget 106 or the alternatives widget 108 to view a matrix corresponding to the fixed-income or the alternatives investment category, respectively. If the user selects the fixed-income widget 106, the system may display graphical user interface 700 as shown in FIG. 7. If the user selects the alternatives widget 108, the system may display graphical user interface 800 as shown in FIG. 8. If the user selects the mixed widget 904, the system may display graphical user interface 1000 as shown in FIG. 10.

In some implementations, the selected investment category is a mixed investment category. The mixed investment category may include asset classes associated with the equities, fixed income, and alternatives investment category. In some implementations, the system provides one or more graphical user interface widgets that allow adjustment of the percentage of the mixed investment category that comprises asset classes associated with each of the equities, fixed income, and alternatives investment categories.

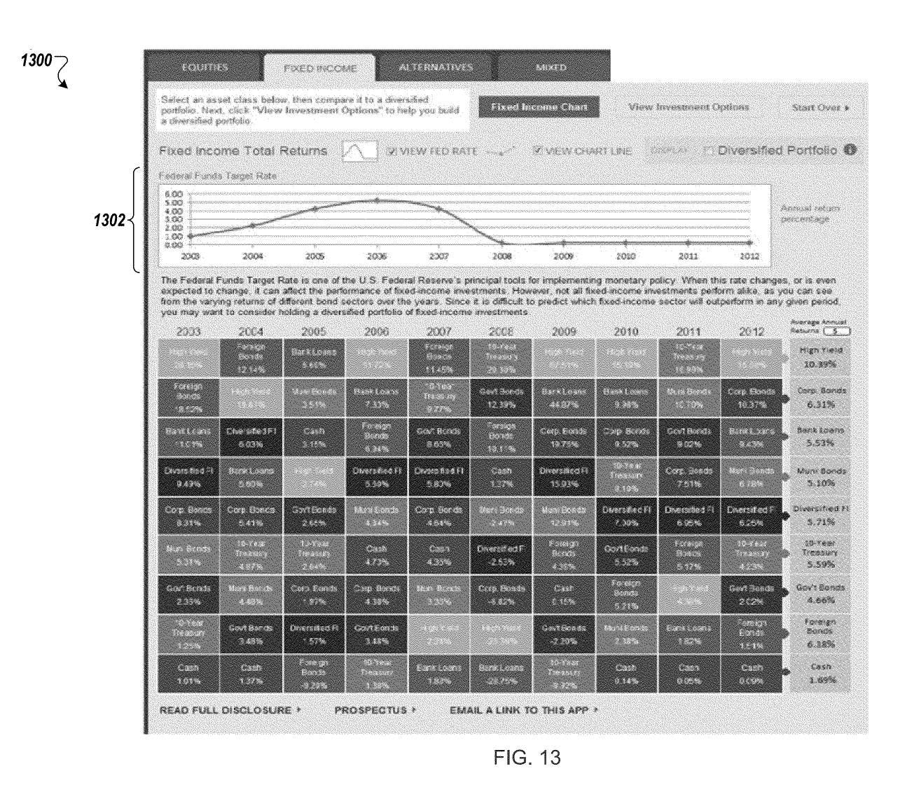

In some implementations, the selected investment category is the fixed income investment category. The graphical user interface associated with the fixed income investment category, such as the graphical user interface shown in FIG. 7, may display federal interest rate information for each time period of the set of time periods. The system may receive federal interest rate information for each time period of the set of time periods and provide, for display on the graphical user interface, the federal interest rate information. The federal interest rate information may be displayed on the graphical user interface, such as graphical user interface 1300 as shown in FIG. 13, as a line graph 1302 comprising fed interest rate information as a function of time.

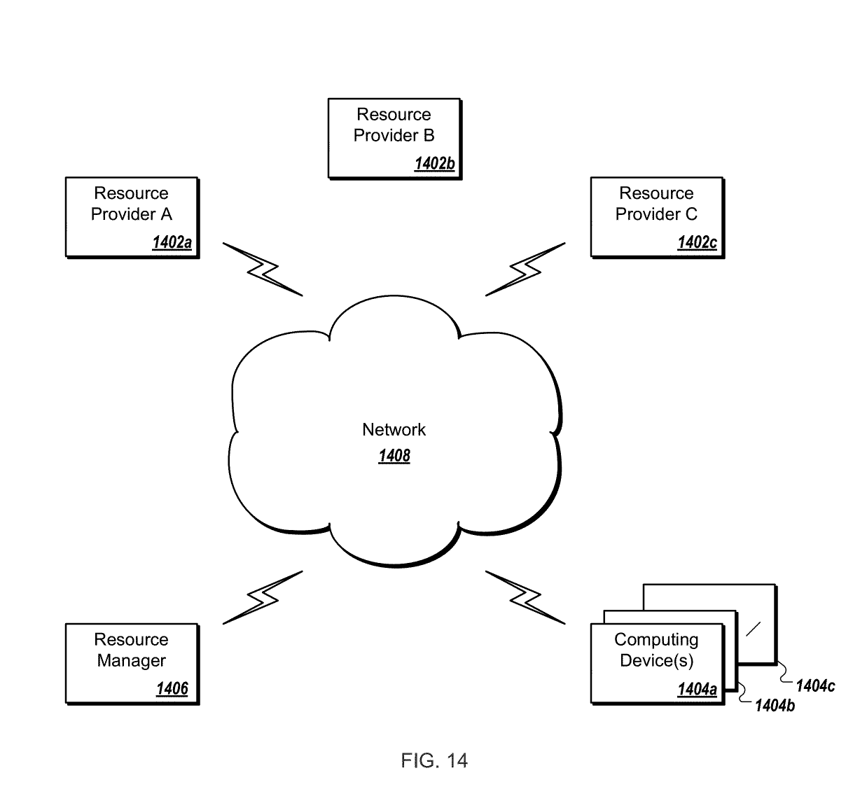

As shown in FIG. 14, an implementation of a network environment 1400 for use in providing an analysis of asset classes and investment categories is shown and described. In brief overview, referring now to FIG. 14, a block diagram of an exemplary cloud computing environment 1400 is shown and described. The cloud computing environment 1400 may include one or more resource providers 1402a, 1402b, 1402c (collectively, 1402). Each resource provider 1402 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 1402 may be connected to any other resource provider 1402 in the cloud computing environment 1400. In some implementations, the resource providers 1402 may be connected over a computer network 1408. Each resource provider 1402 may be connected to one or more computing device 1404a, 1404b, 1404c (collectively, 1404), over the computer network 1408.

The cloud computing environment 1400 may include a resource manager 1406. The resource manager 1406 may be connected to the resource providers 1402 and the computing devices 1404 over the computer network 1408. In some implementations, the resource manager 1406 may facilitate the provision of computing resources by one or more resource providers 1402 to one or more computing devices 1404. The resource manager 1406 may receive a request for a computing resource from a particular computing device 1404. The resource manager 1406 may identify one or more resource providers 1402 capable of providing the computing resource requested by the computing device 1404. The resource manager 1406 may select a resource provider 1402 to provide the computing resource. The resource manager 1406 may facilitate a connection between the resource provider 1402 and a particular computing device 1404. In some implementations, the resource manager 1406 may establish a connection between a particular resource provider 1402 and a particular computing device 1404. In some implementations, the resource manager 1406 may redirect a particular computing device 1404 to a particular resource provider 1402 with the requested computing resource.

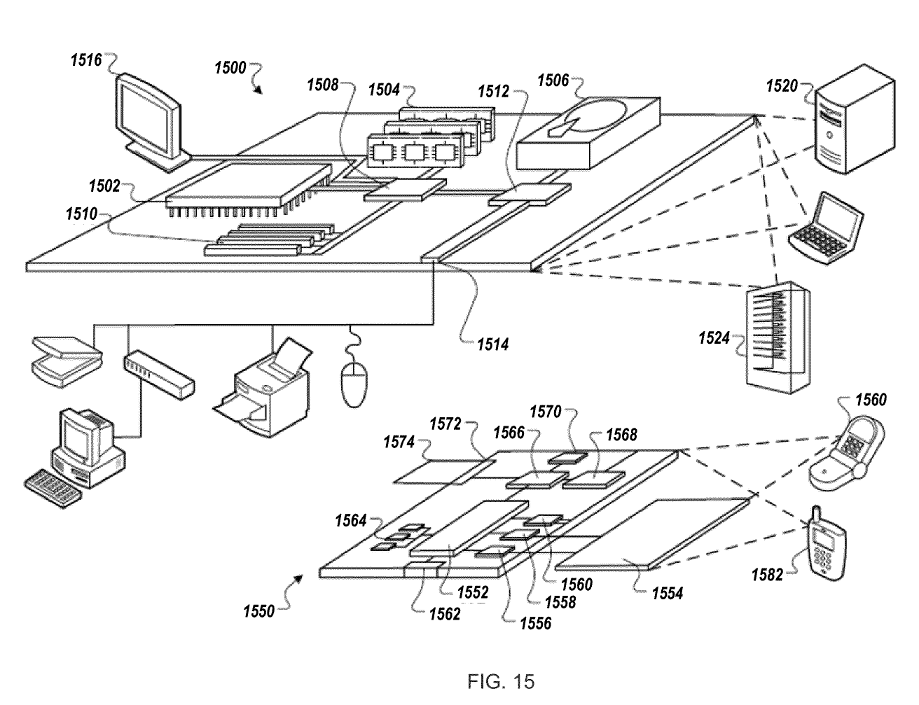

FIG. 15 shows an example of a computing device 1500 and a mobile computing device 1550 that can be used to implement the techniques described in this disclosure. The computing device 1500 is intended to represent various forms of digital computers, such as laptops, desktops, workstations, personal digital assistants, servers, blade servers, mainframes, and other appropriate computers. The mobile computing device 1550 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1500 includes a processor 1502, a memory 1504, a storage device 1506, a high-speed interface 1508 connecting to the memory 1504 and multiple high-speed expansion ports 1510, and a low-speed interface 1512 connecting to a low-speed expansion port 1514 and the storage device 1506. Each of the processor 1502, the memory 1504, the storage device 1506, the high-speed interface 1508, the high-speed expansion ports 1510, and the low-speed interface 1512, are interconnected using various busses, and may be mounted on a common motherboard or in other manners as appropriate. The processor 1502 can process instructions for execution within the computing device 1500, including instructions stored in the memory 1504 or on the storage device 1506 to display graphical information for a GUI on an external input/output device, such as a display 1516 coupled to the high-speed interface 1508. In other implementations, multiple processors and/or multiple buses may be used, as appropriate, along with multiple memories and types of memory. A processor may include one or more processors. Also, multiple computing devices may be connected, with each device providing portions of the necessary operations (e.g., as a server bank, a group of blade servers, or a multi-processor system).

The memory 1504 stores information within the computing device 1500. In some implementations, the memory 1504 is a volatile memory unit or units. In some implementations, the memory 1504 is a non-volatile memory unit or units. The memory 1504 may also be another form of computer-readable medium, such as a magnetic or optical disk.

The storage device 1506 is capable of providing mass storage for the computing device 1500. In some implementations, the storage device 1506 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1502), perform one or more methods, such as those described above. The instructions can also be stored by one or more storage devices such as computer- or machine-readable mediums (for example, the memory 1504, the storage device 1506, or memory on the processor 1502).

The high-speed interface 1508 manages bandwidth-intensive operations for the computing device 1500, while the low-speed interface 1512 manages lower bandwidth-intensive operations. Such allocation of functions is an example only. In some implementations, the high-speed interface 1508 is coupled to the memory 1504, the display 1516 (e.g., through a graphics processor or accelerator), and to the high-speed expansion ports 1510, which may accept various expansion cards (not shown). In the implementation, the low-speed interface 1512 is coupled to the storage device 1506 and the low-speed expansion port 1514. The low-speed expansion port 1514, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 1500 may be implemented in a number of different forms, as shown in the figure. For example, it may be implemented as a standard server 1520, or multiple times in a group of such servers. In addition, it may be implemented in a personal computer such as a laptop computer 1522. It may also be implemented as part of a rack server system 1524. Alternatively, components from the computing device 1500 may be combined with other components in a mobile device (not shown), such as a mobile computing device 1550. Each of such devices may contain one or more of the computing device 1500 and the mobile computing device 1550, and an entire system may be made up of multiple computing devices communicating with each other.

The mobile computing device 1550 includes a processor 1552, a memory 1564, an input/output device such as a display 1554, a communication interface 1566, and a transceiver 1568, among other components. The mobile computing device 1550 may also be provided with a storage device, such as a micro-drive or other device, to provide additional storage. Each of the processor 1552, the memory 1564, the display 1554, the communication interface 1566, and the transceiver 1568, are interconnected using various buses, and several of the components may be mounted on a common motherboard or in other manners as appropriate.

The processor 1552 can execute instructions within the mobile computing device 1550, including instructions stored in the memory 1564. The processor 1552 may be implemented as a chipset of chips that include separate and multiple analog and digital processors. The processor 1552 may provide, for example, for coordination of the other components of the mobile computing device 1550, such as control of user interfaces, applications run by the mobile computing device 1550, and wireless communication by the mobile computing device 1550.

The processor 1552 may communicate with a user through a control interface 1558 and a display interface 1556 coupled to the display 1554. The display 1554 may be, for example, a TFT (Thin-Film-Transistor Liquid Crystal Display) display or an OLED (Organic Light Emitting Diode) display, or other appropriate display technology. The display interface 1556 may comprise appropriate circuitry for driving the display 1554 to present graphical and other information to a user. The control interface 1558 may receive commands from a user and convert them for submission to the processor 1552. In addition, an external interface 1562 may provide communication with the processor 1552, so as to enable near area communication of the mobile computing device 1550 with other devices. The external interface 1562 may provide, for example, for wired communication in some implementations, or for wireless communication in other implementations, and multiple interfaces may also be used.

The memory 1564 stores information within the mobile computing device 1550. The memory 1564 can be implemented as one or more of a computer-readable medium or media, a volatile memory unit or units, or a non-volatile memory unit or units. An expansion memory 1574 may also be provided and connected to the mobile computing device 1550 through an expansion interface 1572, which may include, for example, a SIMM (Single In Line Memory Module) card interface. The expansion memory 1574 may provide extra storage space for the mobile computing device 1550, or may also store applications or other information for the mobile computing device 1550. Specifically, the expansion memory 1574 may include instructions to carry out or supplement the processes described above, and may include secure information also. Thus, for example, the expansion memory 1574 may be provided as a security module for the mobile computing device 1550, and may be programmed with instructions that permit secure use of the mobile computing device 1550. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 1552), perform one or more methods, such as those described above. The instructions can also be stored by one or more storage devices, such as one or more computer- or machine-readable mediums (for example, the memory 1564, the expansion memory 1574, or memory on the processor 1552). In some implementations, the instructions can be received in a propagated signal, for example, over the transceiver 1568 or the external interface 1562.

The mobile computing device 1550 may communicate wirelessly through the communication interface 1566, which may include digital signal processing circuitry where necessary. The communication interface 1566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1568 using a radio-frequency. In addition, short-range communication may occur, such as using a Bluetooth®, Wi-Fi™, or other such transceiver (not shown). In addition, a GPS (Global Positioning System) receiver module 1570 may provide additional navigation- and location-related wireless data to the mobile computing device 1550, which may be used as appropriate by applications running on the mobile computing device 1550.

The mobile computing device 1550 may also communicate audibly using an audio codec 1560, which may receive spoken information from a user and convert it to usable digital information. The audio codec 1560 may likewise generate audible sound for a user, such as through a speaker, e.g., in a handset of the mobile computing device 1550. Such sound may include sound from voice telephone calls, may include recorded sound (e.g., voice messages, music files, etc.) and may also include sound generated by applications operating on the mobile computing device 1550.

The mobile computing device 1550 may be implemented in a number of different forms, as shown in the figure. For example, it may be implemented as a cellular telephone 1580. It may also be implemented as part of a smart-phone 1582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer, such as a desktop computer, laptop computer, netbook, tablet, mobile phone, or other mobile computing device, having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

The term “widget,” as used herein, refers to one or more of any number of the following: a window (e.g., collapsible panel, accordion, modal window, dialog box, palette window, inspector window, utility window, or frame), a text box, a button, a hyperlink, a drop-down list, a list box, a combo box, a check box, a radio button, a cycle button, a data grid, a spinner, a menu (e.g., context menu, pie menu, ribbon), a menu bar, a toolbar, an icon, a tree view, a grid view, a link, a tab, a toggle switch, and/or a scroll bar.

In view of the structure, functions and apparatus of the systems and methods described here, in some implementations, a system and method for providing an analysis of asset classes and investment categories are provided. Having described certain implementations of methods and apparatus for supporting an analysis of asset classes and investment categories, it will now become apparent to one of skill in the art that other implementations incorporating the concepts of the disclosure may be used. Therefore, the disclosure should not be limited to certain implementations, but rather should be limited only by the spirit and scope of the following claims.

Throughout the description, where apparatus and systems are described as having, including, or comprising specific components, or where processes and methods are described as having, including, or comprising specific steps, it is contemplated that, additionally, there are apparatus, and systems of the disclosed technology that consist essentially of, or consist of, the recited components, and that there are processes and methods according to the disclosed technology that consist essentially of, or consist of, the recited processing steps.

It should be understood that the order of steps or order for providing certain action is immaterial so long as the disclosed technology remains operable. Moreover, two or more steps or actions may be conducted simultaneously.

What is claimed:

1. A computer-implemented method for displaying financial asset performance information, the method comprising the steps of:
receiving, by a processor of a computing device, financial performance information for a set of asset classes in one or more investment categories, wherein:
the financial performance information includes, for each asset class, a return for each time period of a set of time periods, and
each asset class is associated with one of the one or more investment categories, and
the one or more investment categories are selected from the group consisting of equities, fixed income, alternatives, and mixed;
providing, by the processor, a graphical user interface configured to accept user input;
receiving, by the processor, a selection of an investment category, wherein:
the graphical user interface displays a matrix of financial performance information arranged on a first axis by the set of time periods and on a second axis by financial performance,
for each time period of the set of time periods, the matrix includes an entry corresponding to each asset class of the set of asset classes associated with the selected investment category, and
the entries in the matrix for each time period of the set of time periods are organized based on the financial performance information in the corresponding time period;
receiving, by the processor, a selection by a user of an entry in the matrix, wherein the selected entry corresponds to a selection of an asset class associated with the selected investment category; and
graphically highlighting, on the graphical user interface, by the processor, all entries in the matrix over the set of time periods corresponding to the selected asset class.

2. The method of claim 1, wherein the set of time periods comprises a set of years.

3. The method of claim 2, wherein the return is an annual return.

4. The method of claim 3, wherein the set of asset classes associated with the selected investment category includes a diversified asset class, and for each time period of the set of time periods, the matrix includes an entry corresponding to the diversified asset class that represents an average annual return for each given time period of the other members of the set of asset classes associated with the selected investment category.

5. The method of claim 1, wherein the selection of the investment category is received from a computing device associated with a user.

6. The method of claim 5, further comprising:
receiving, by the processor, a selection by the user of a second investment category; and
updating, by the processor, the graphical user interface display a matrix with an entry corresponding to each asset class of the set of asset classes associated with the second investment category.

7. The method of claim 1, wherein the selected investment category is a mixed investment category, and the mixed investment category includes asset classes associated with the equities, fixed income, and alternatives investment category.

8. The method of claim 7, further comprising:
providing, by the processor, one or more graphical user interface widgets that allow adjustment of the percentage of the mixed investment category that comprises asset classes associated with each of the equities, fixed income, and alternatives investment category.

9. The method of claim 1, wherein the selected investment category is the fixed income investment category, and the method further comprising:
receiving, by the processor, federal interest rate information for each time period of the set of time period; and
providing, by the processor, for display on the graphical user interface, the federal interest rate information.

10. The method of claim 9, wherein the federal interest rate information is provided, for display on the graphical user interface, as a line graph comprising fed interest rate information as a function of time.

11. The method of claim 1, wherein the one or more investment categories include an equities, fixed income, alternatives, and a mixed investment category.

12. The method of claim 11, wherein the asset classes associated with the equities investment category include small-cap growth, small-cap value, mid-cap growth, foreign equities, mid-cap value, large-cap value, large blend, and large-cap growth.

13. The method of claim 11, wherein the asset classes associated with the fixed income investment category include high yield, foreign bonds, bank loans, corporate bonds, municipal bonds, government bonds, 10-year U.S. treasury, and cash.

14. The method of claim 11, wherein the asset classes associated with the alternatives investment category include precious metals, global real estate, emerging markets debt, commodities, buy/write, long/short equity, and market neutral.

15. The method of claim 11, wherein the asset classes associated with the mixed investment category include one or more asset classes selected from the asset classes associated with the equities, the fixed income, and/or the alternatives investment category.

16. The method of claim 1, further comprising: providing, for display on the graphical user interface, an average annual return over a period of time for each asset class in the selected investment category.

17. The method of claim 1, wherein graphically highlighting all entries in the matrix corresponding to the selected asset class comprises a line connecting each of the entries in the matrix in the selected asset class.

18. The method of claim 1, wherein graphically highlighting all entries in the matrix corresponding to the selected asset class comprises a first background color for each of the entries in the matrix in the selected asset class and a second background color for all entries in the matrix that are not in the selected asset class.

19. The method of claim 1, wherein the graphical user interfaces displays the growth of an investment amount over a time period.

20. A system for displaying financial asset performance information, the system comprising:
a processor configured to process data to display financial asset performance information, wherein the processor is configured to execute instructions to:
receive financial performance information for a set of asset classes in one or more investment categories, wherein:
the financial performance information includes, for each asset class, a return for each time period of a set of time periods,
each asset class is associated with one of the one or more investment categories, and
the one or more investment categories are selected from the group consisting of equities, fixed income, alternatives, and mixed;
provide a graphical user interface configured to accept user input;
receive a selection of an investment category, wherein:
the graphical user interface displays a matrix of financial performance information arranged on a first axis by the set of time periods and on a second axis by financial performance,
for each time period of the set of time periods, the matrix includes an entry corresponding to each asset class of the set of asset classes associated with the selected investment category, and
the entries in the matrix for each time period of the set of time periods are organized based on the financial performance information in the corresponding time period;
receive a selection by a user of an entry in the matrix, wherein the selected entry corresponds to a selection of an asset class associated with the selected investment category;
graphically highlight, on the graphical user interface, all entries in the matrix over the set of time periods corresponding to the selected asset class.
